(19) United States
(12) Patent Application Publication
(10) Pub. No.: US 2011/0271594 A1
(43) Pub. Date: Nov. 10, 2011

(54) PRECAST RADIATION PROTECTION BOARD

(76) Inventor: CHI-KUANG CHEN, New Taipei City (TW)

(21) Appl. No.: 13/043,461

(22) Filed: Mar. 9, 2011

(30) Foreign Application Priority Data
May 5, 2010 (CN) 201020201133.2

(51) Int. Cl. E06B 5/18; E04C 2/04; G21F 1/12; E04C 2/06; B32B 13/00; B32B 3/06

(52) U.S. Cl. 49/70; 428/448; 428/192; 428/188; 428/99

(57) ABSTRACT

The present invention relates to a precast radiation protection board, which is structured for jointing another protection board. The protection board includes a protection layer that is formed of a mixture of barium sulfate and cement and outside isolation plates that are respectively attached to opposite sides of the protection layer. The outside isolation plates are fiber cement boards. This arrangement allows the precast structure to be efficiently installed and allows for direct painting or decorative coating, so as to significantly reduce operation time.

### (a) TECHNICAL FIELD OF THE INVENTION

The present invention generally relates to a radiation protection board, and more particularly to a novel precast radiation protection board that allows for efficient installation, easy decorative coating, and offering a protection against leakage of radiation.

### (b) DESCRIPTION OF THE PRIOR ART

Medical facilities or hospitals are provided with an X-ray room, which is a radiotherapeutic unit. To prevent leakage or undesired transmission of X-ray, the construction of the X-ray room is often such that a lead cover is attached to a brick wall to realize the protection against radiation.

It is commonly known that the brick wall that carries the radiation protection is further processed by application of cement paste to the wall surface for formation of a flat and smooth surface to which decorative coating can be applied to complete the construction.

Such a construction process is generally time- and labor-consuming for workers must first establish the brick wall and the apply cement paste to the wall surface for leveling the irregular brick wall surface. This process is commonly known and is also time- and labor-consuming.

### SUMMARY OF THE INVENTION

A primary objective of the present invention is to provide a protection board, which is structured for jointing another protection board. The protection board comprises a protection layer that is formed of a mixture of barium sulfate and cement and two outside isolation plates respectively attached to opposite sides of the protection layer. The outside isolation plates are fiber cement boards. The outside isolation plate forms, on a side thereof opposite to the side attached to the protection layer, a smooth surface to which coating and decoration can be directly applied. As such, when it is desired to erect the protection board as partition, a user may directly mount the board and directly applies painting or other decorative coating to a smooth surface of the board. With such an arrangement, the conventional way of first manually laying and stacking bricks to construct a wall and then applying cement paste to a surface of the wall to smoothen the rough bricked surface for leveling, which is a commonly known process, but is time- and labor-consuming, can be improved to thereby achieve practical advantages of efficient construction, easy coating and decorating, and also offering protection against leakage of radiation.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a radiation protection board according to a preferred embodiment of the present invention.

FIG. 2 is a cross-sectional view of the preferred embodiment of the present invention.

FIG. 3 is a schematic view showing jointing between the protection boards according to the present invention.

FIG. 4 is a schematic view showing an application of the preferred embodiment of the present invention.

FIG. 5 is a schematic view showing an application of another embodiment according to the present invention.

FIG. 6 is a schematic view showing a schematic view of a further embodiment of the present invention.

FIG. 7 is a schematic view showing a further embodiment according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

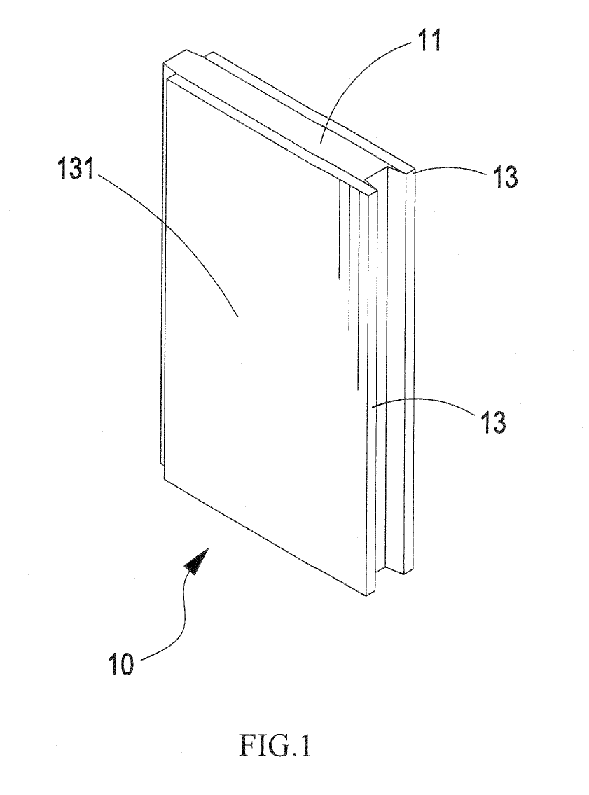

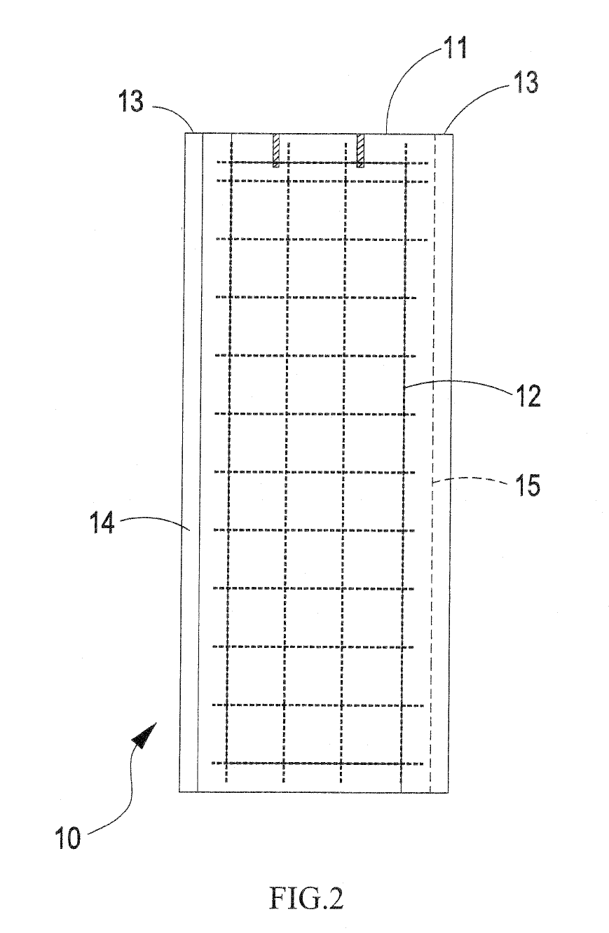

Referring to FIGS. 1 and 2, which are respectively a perspective view and a cross-sectional view of a radiation protection board according to a preferred embodiment of the present invention, the drawings clearly show that the protection board of the present invention is structured for jointing another one of the protection board and is characterized in that the protection board 10 is composed of a protection layer 11 made of a mixture of barium sulfate and cement and two outside isolation plates 13 that are respectively attached to opposite surfaces of the protection layer 11. The outside isolation plates 13 are each a fiber cement board. Further, the outside isolation plate 13 forms, on the side opposite to that attached to the protection layer 11, a smooth surface 131 on which coating or decoration can be made.

Further, the protection board 10 has an end forming a projection 14 and an opposite end forming a recess 15, whereby the projection 14 of one protection board is mateable and receivable in the recess 15 of another protection board 10 for coupling. Further, the protection board 10 comprises a steel wire grid 12 that is formed by means of welding to reinforce the protection board 10.

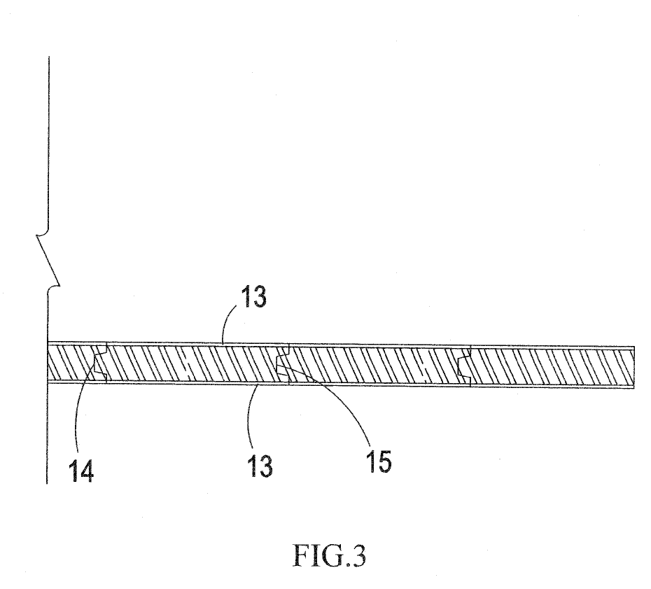

As shown in FIGS. 2 and 3, which are respectively a cross-sectional view of the preferred embodiment of the present invention and a schematic view showing jointing between protection boards according the present invention, the drawings clearly show that the protection board 10 is composed of a protection layer 11 and at least one outside isolation plate 13. The protection board 10 has an end forming a projection 14 and an opposite end forming a recess 15, whereby the projection 14 of one protection is mateable and receivable in the recess 15 of another protection board 10 for coupling. As shown in the drawings, when a user attempts to couple multiple protection boards 10 together, the projection 14 of one of the protection boards 10 is fit into and coupled to the recess 15 of another one of the protection boards 10 to for an edge-to-edge joint.

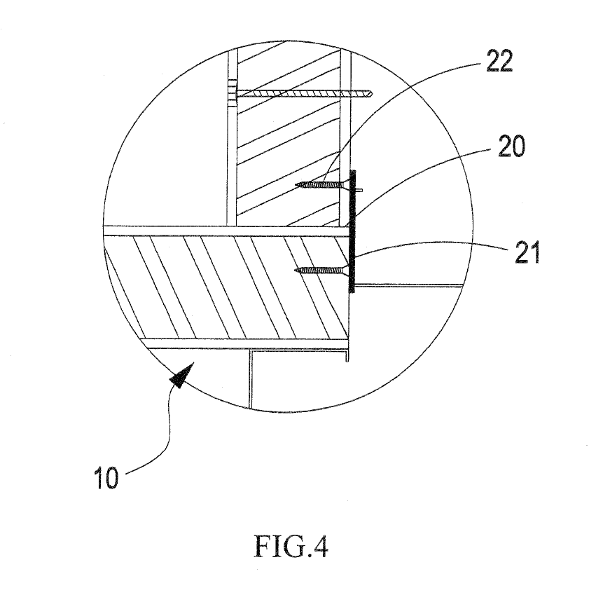

Referring to FIG. 4, which is a schematic view showing an application of the preferred embodiment of the present invention, the drawing clearly shows that the protection board 10 and another protection board 10 that is substantially perpendicular to the previous one form a gap 20 therebetween. A shielding body 21 is positioned to cover and shield the gap 20 and is fixed by fasteners 22 to the protection boards 10, whereby undesired penetration of radiation through the gap 20 can be prevented.

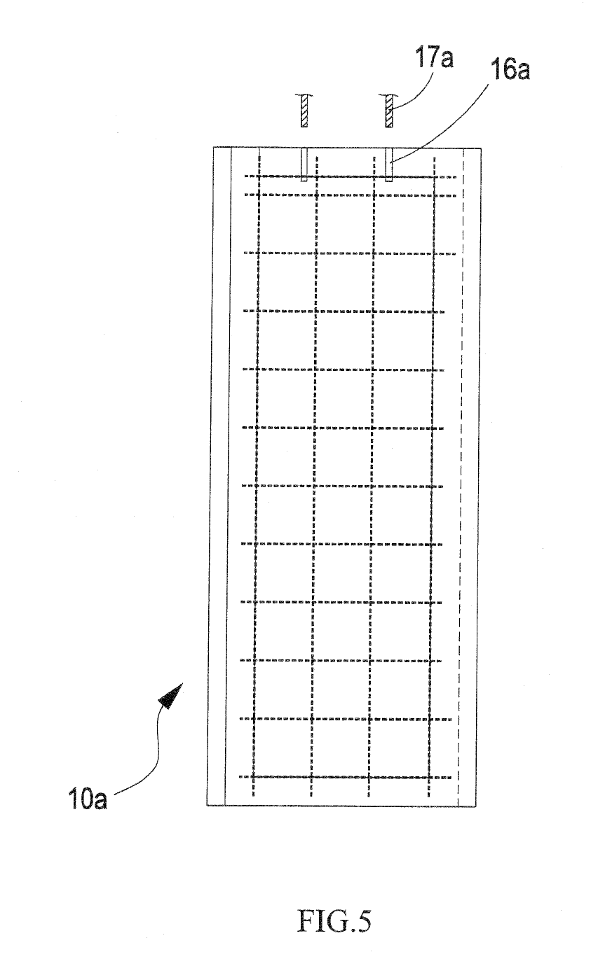

Referring to FIG. 5, which is a schematic view showing an application of another embodiment according to the present invention, the drawing clearly shows that a protection board 10a forms at least one pre-formed threaded hole 16a, and a threaded bar 17a is insertable into and thus connectable to the pre-formed threaded hole 16a, whereby a lifting device can be used to lift the protection board 10a for easy transportation and thus facilitating the operation thereof.

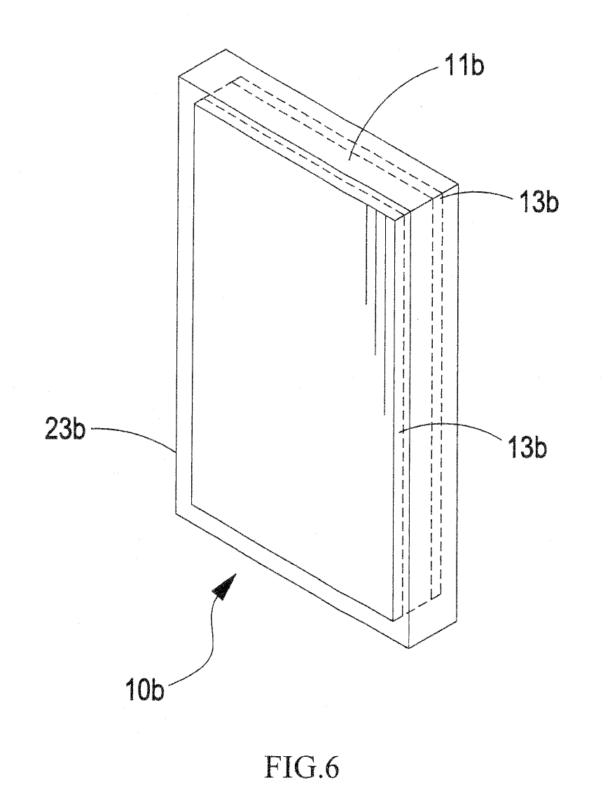

Referring to FIG. 6, which is a schematic view showing a schematic view of a further embodiment of the present invention, the drawing clearly shows that a protection board 10b comprises a protection layer 11b that is formed of a mixture of barium sulfate and cement, two outside isolation plates 13b respectively attached to opposite sides of the protection layer 11b, and an outer frame 23b circumferentially surrounding the protection board 10b, whereby the embodiment of the present invention is applicable to a gate door that is either a swing door or a sliding door.

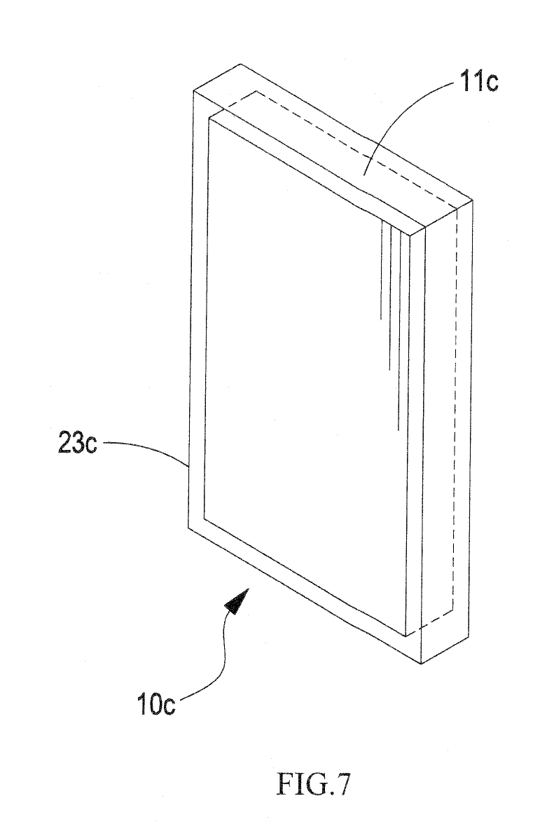

Referring to FIG. 7, which is a schematic view showing a further embodiment according to the present invention, the drawing clearly shows that a protection board 10c comprises a protection layer 11c made of a mixture of barium sulfate and cement and an outer frame 23c circumferentially surrounding the protection layer 11c, whereby the embodiment is applicable to a gate door, which is either a swing door or a sliding door.

Thus, as shown in the attached drawings, the present invention, when compared to the conventional technologies, shows advantages that are briefly described as follows:

(1) The arrangement of the outside isolation plates 13 allows the protection board 10 to be directly worked for coating and decorating the smooth surface 131 without an additional operation of leveling by applying cement paste thereto.

(2) The arrangement of the pre-formed threaded hole 16a allows easy transportation in a construction operation.

(3) A well mated joint can be formed when one protection board 10 is coupled to another protection board 10 and the protection boards 10 can be jointed first before partitioning is performed, so that the construction operation is not affected by the condition of weather of the construction site.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A precast radiation protection board, which is joinable to another protection board, characterized in that:
the protection board comprises a protection layer primarily formed of a mixture of barium sulfate and cement and outside isolation plates respectively attached to opposite sides of the protection layer.

2. The precast radiation protection board according to claim 1, wherein the outside isolation plates comprise fiber cement boards.

3. The precast radiation protection board according to claim 1, wherein the outside isolation plate forms, on one side thereof opposite to a side attached to the protection layer, a smooth surface for coating and decoration.

4. The precast radiation protection board according to claim 1, wherein the protection board has an end forming a projection and an opposite end forming a recess, the projection being mateable to and receivable in the recess of said another protection board.

5. The precast radiation protection board according to claim 1, wherein the protection board has an end forming at least one threaded hole.

6. The precast radiation protection board according to claim 1, wherein the protection board comprises a steel wire grid formed by welding arranged therein to reinforce the protection board.

7. The precast radiation protection board according to claim 1, wherein a gap is formed between the protection board and said another protection board, a shielding body being set to cover and shield the gap.

8. The precast radiation protection board according to claim 7, wherein the shielding body is fixed by fasteners to the protection board.

9. The precast radiation protection board according to claim 1, wherein the protection board is applicable to a gate door.

10. The precast radiation protection board according to claim 9, wherein the gate door comprises a swing door or a sliding door.

11. The precast radiation protection board according to claim 1, wherein the protection layer comprises an outer frame circumferentially surrounding the protection layer to form a gate door.

12. The precast radiation protection board according to claim 11, wherein the gate door comprises a swing door or a sliding door.
